(19) United States
(12) Patent Application Publication
(10) Pub. No.: US 2017/0257283 A1
(43) Pub. Date: Sep. 7, 2017

(54) SYSTEM AND INTERFACES FOR ENTITY MANAGEMENT

(71) Applicant: Ipswitch, Inc., Lexington, MA (US)

(72) Inventors: Austin O'Malley, Acton, MA (US); Vajrang Suresh Parvate, Bedford, MA (US); Swetha Desetty, Roswell, GA (US); Linda Upham Ellis, NE Roswell, GA (US)

(73) Assignee: Ipswitch, Inc., Lexington, MA (US)

(21) Appl. No.: 15/448,336

(22) Filed: Mar. 2, 2017

Related U.S. Application Data
(60) Provisional application No. 62/302,546, filed on Mar. 2, 2016.

(51) Int. Cl. H04L 12/24; G06F 3/0484

(52) U.S. Cl. CPC H04L 41/22; G06F 3/0484; H04L 41/12; G06F 2203/04806; G06F 3/04842

(57) ABSTRACT

A management interface is provided that allows for more capability to view and create indications of such complex relationships between entities. For instance, it would be helpful to have an ability to view physical, virtual, and/or wireless connectivity within a common interface. Further, tools may be provided to permit the user to more easily navigate a representation of the network and its entities, and to perform management control actions, monitoring, and other functions.

### RELATED APPLICATIONS

This application claims priority under 35 U.S.C. §119(e) to U.S. Provisional Patent Application Ser. No. 62/302,546, entitled “SYSTEM AND INTERFACES FOR ENTITY MANAGEMENT,” filed Mar. 2, 2016, incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### SUMMARY

Systems exist that permit users (e.g., IT management personnel) to actively manage entities such as computer systems, communication systems, applications, and other virtual and actual resources that are used to provide computer services functions to users. It is appreciated that the relationships between entities that provide such services are very complex and existing software tools used to visualize and troubleshoot such networks are not sufficient.

What is needed is a system and associated interfaces that permit users to more easily view relationships between entities to more efficiently manage resources. For instance, it is appreciated that there may be complex relationships between assets such as network communication equipment, servers, desktops, applications and other assets. Further, it is appreciated that it may be helpful to record and visualize various aspects that these particular assets provide. For instance, certain assets may perform various aspects, such as those related to infrastructure, security, data flow, and/or user-defined aspects such as location, logical grouping, or the like. The system and user interface may be modified to visualize such aspects. Further, assets may include one or more medium classifications, such as physical (e.g., hardware), virtual (e.g., VM, SDN, VDI, etc.), cloud (e.g., Salesforce, Amazon, etc.), location (e.g., geography, site locations, etc.) that can be visualized and/or represented by the system.

Also, a management interface may be provided that allows for more capability to view and create indications of such complex relationships between entities. For instance, it would be helpful to have an ability to view physical, virtual, and/or wireless connectivity within a common interface. Further, tools may be provided to permit the user to more easily navigate a representation of the network and its entities, and to perform management control actions, monitoring, and other functions. Such an interface is more efficient, as users would need to perform less computer operations to view the same amount of data.

According to one aspect, a system is provided that allows for a single, graphical view of what is important to the IT management team. For instance, the system may provide an interface that a user to turn on-off perspectives of particular connectivity layers between entities. Information may be displayed graphically as a series of overlays which can be suppressed/unsuppressed within the interface, providing additional operational efficiencies. Also, the interface may permit the user to drill into more details by implementing zooming. In one embodiment, the system has various representations of an object depending on its zoom level, and depending on a selected zoom level, the interface shows various level of detail for the entity. In one embodiment, each item is represented as an object with an available card that can be viewed and edited.

In another embodiment, the interface may be configured to provide different perspectives of information associated with an entity. For instance, the interface may be configured to indicate an asset type associated with the entity. For instance, the entity may be one of several defined asset types including: Network, Server, Desktop, Application assets. The interface may also be configured to indicate a particular medium (and location) associated with the asset. For example, the medium/location may be indicated as an Enterprise/Physical, Virtual (VM, VDI, SDN), Cloud, or other medium type. Further, as discussed above, the entity may perform certain aspects within the communication network, including, for example, Infrastructure, Security, and Data-related aspects.

Because assets are viewed in terms of their functions performed on the network and their relations to users, the interface operates more efficiently and permits easy understanding, monitoring, and resolution of problems. For instance, the interface may allow quick visualization of the correlation of assets that are tied to a user and what access the users have to those assets. The interface may also provide a view of the Quality of Service the end user (or group of end users) is having in relation to those assets. Further, it may be determined who was involved when particular anomalies occur—e.g., data breaches, suspicious activity, etc. The system may use relationship information between network elements and data to trace back faults to an asset and particular users.

Further, as discussed above, one aspect of the present invention relates to an improved user interface for viewing interconnected entities. For instance, in one implementation, entities are depicted on a map with connections between them. The entities are depicted as visual representations within the map, and connections are shown in relation to what layers or view is selected. For instance, within the user interface, a layer 2 control may be selected that causes the system to show all layer 2 connections between the entities.

As discussed, another feature allows the user to zoom into one or more entities within the interface. For instance, in a first level, there is a view of an overview of the network. In this instance, devices are depicted as small elements interconnected with one another. In a next level of zoom, devices are depicted as icons which indicate particular devices and/or entities. In a further zoom level, the names of each entity are viewable, and in a last level of zoom, individual interfaces associated with a particular entity may be viewed.

Entities within the interface may be shown by their relation responsive to selections of particular controls within the interface. For instance, in a wireless connectivity control, devices that have common wireless connectivity may be grouped together with connections as shown to the user within the interface. Other groupings may be used such as logical “cloud” groupings which can be done by subnet, location, or any other user-defined grouping.

Also as discussed, the interface may include one or more overlays which display particular connectivity between entities. For instance, control presented within the user interface may display OSI layer 2 and layer 3, Virtual connectivity, Wireless connectivity or any other type of connectedness indication. Such representations may permit the user to easily locate connectivity in a number of different planes for the purpose of troubleshooting, performing management actions, viewing performance or performing any other actions.

According to another aspect of the present invention, the user interface may include a number of controls that can easily locate and group particular entities. For instance, the interface may include an input that permits a user to locate a particular entity or groups of entities based on some searchable parameter associated with those entities. When entered, the parameter may be used to locate the particular entities and display only those filter entities within the map display. Those entities may be grouped (e.g., via selection tool, mouse, and/or combination of user controls). After grouping, such entities may be operated on as a group and made allow the management user to more efficiently perform management operations.

Further, because entities more may be more easily located and grouped, additional tools may be provided that can be more easily applied to multiple entities. For instance, a palette of tools may be provided such that multiple actions may be performed on multiple entities. For instance, credentials associated with a particular entity may be applied to multiple entities by a simple drag/drop action performed within the interface. To accomplish this, a credential tool may be provided within the interface that could be dragged and dropped onto one or more entities. Because management actions are simplified to interface actions that can be performed within few steps, a more efficient management system results. In another example, monitoring on particular entities may be defined and provided as a tool that can be dragged and dropped onto particular entities.

In another embodiment, entities may also have associated cards that are displayed within the interface that allows quick access to information associated with those items. For instance, a card may include information such as the item type, credentials, status, or any other related information to the entity. Such cards may be located within a small number of steps within the interface (e.g., a right click of a mouse or a menu action associated with a selected entity).

In yet another implementation, the system may be capable of defining dependency chains between entities that can be displayed within the interface to a user. In one embodiment, the dependency chain may be defined directionally, such that if an entity A goes down, entity B is listed as down within the interface. Such dependency chains may be created automatically by the system or may be created by the user within the interface (e.g., by using a drawing tool). In one embodiment, the user applies the dependency indication graphically and directionally, such as by drawing a line within the interface from one entity (a source entity) to another entity (a target entity) that inherits the state, status, or other indication from the source entity.

According to another aspect, the system may be capable of determining, during an automatic discovery process, whether the system needs credentials for particular entities. The system may be capable of indicating, within an entity map or other notification, that credentials are needed for certain defined entities. Optionally, the system may be capable of prompting the user for such credential information, as the map is completed by one or more asynchronous discovery processes.

According to one aspect of the present invention, an entity management system is provided comprising a discovery engine configured to discover a plurality of computing entities coupled by one or more communication networks, a mapping component adapted to represent the plurality of discovered computing entities and associated connections in a plurality of dimensions in a graphical map, and an interface configured to represent the plurality of discovered computing entities and their connections in the plurality of dimensions within a single end user display.

In one embodiment, the system further comprises at least one user interface control that when selected, causes the interface to display at a group of connections in at least one of the least one of the plurality of dimensions. In another embodiment, the system further comprises at least one user interface control that when selected, causes the interface to perform a zooming operation within the graphical map, wherein the zoom operation operates to select a zoom level with corresponding detail relating to the plurality of discovered computing entities.

In yet another embodiment, the system further comprises at least one user interface control that when selected, causes the interface to create a dependency between at least two entities, wherein one of at least one of the two entities is indicated to have a dependent relationship with the other of the at least two entities, and wherein the dependency relationship is indicated as a connection within the display. In another embodiment, the system further comprises at least one user interface control that when selected, causes the interface to group at least a subset of the plurality of discovered computing entities.

In another embodiment of the present invention, the system further comprises at least one user interface control that when selected, causes the management system to perform a management action on the selected subset of the plurality of discovered computing entities. In yet another embodiment, the management action is at least one of a group comprising a monitor action, an application of a credential, and a grouping action.

In another embodiment, the system further comprises at least one user interface control that when selected, causes the interface to filter the plurality of discovered computing entities. In another embodiment, the at least one user interface control comprises an input, and wherein the system accepts a user input that causes the interface to filter the plurality of discovered computing entities, and to display a filtered map of discovered computing entities that match the user input.

According to another aspect of the present invention, a non-volatile computer-readable medium encoded with instructions for execution on a computer system is provided, the instructions when executed, provide an entity management system comprising a discovery engine configured to discover a plurality of computing entities coupled by one or more communication networks, a mapping component adapted to represent the plurality of discovered computing entities and associated connections in a plurality of dimensions in a graphical map, and an interface configured to represent the plurality of discovered computing entities and their connections in the plurality of dimensions within a single end user display.

According to one embodiment, the system further comprises at least one user interface control that when selected, causes the interface to display at a group of connections in at least one of the least one of the plurality of dimensions. In another embodiment, the system further comprises at least one user interface control that when selected, causes the interface to perform a zooming operation within the graphical map, wherein the zoom operation operates to select a zoom level with corresponding detail relating to the plurality of discovered computing entities.

According to another embodiment, the system further comprises at least one user interface control that when selected, causes the interface to create a dependency between at least two entities, wherein one of at least one of the two entities is indicated to have a dependent relationship with the other of the at least two entities, and wherein the dependency relationship is indicated as a connection within the display.

In another embodiment, the system further comprises at least one user interface control that when selected, causes the interface to group at least a subset of the plurality of discovered computing entities. In yet another embodiment, the system further comprises at least one user interface control that when selected, causes the management system to perform a management action on the selected subset of the plurality of discovered computing entities.

In one embodiment, the management action is at least one of a group comprising a monitor action, an application of a credential, and a grouping action. According to another embodiment, the system further comprises at least one user interface control that when selected, causes the interface to filter the plurality of discovered computing entities. In another embodiment, the at least one user interface control comprises an input, and wherein the system accepts a user input that causes the interface to filter the plurality of discovered computing entities, and to display a filtered map of discovered computing entities that match the user input.

According to another aspect, a method is provided comprising discovering, via a management system, a plurality of computing entities coupled by one or more communication networks, the management system being coupled to the one or more communication networks, representing, within a display of the management system, the plurality of discovered computing entities and associated connections in a plurality of dimensions in a graphical map, and representing the plurality of discovered computing entities and their connections in the plurality of dimensions within a single end user display. In one embodiment, the method further comprises an act of displaying, responsive to a user activation of at least one user interface control that when selected, causes the interface to display at a group of connections in at least one of the least one of the plurality of dimensions. In another embodiment, the method further comprises an act of performing, responsive to a selection of a control, a zooming operation within the graphical map, wherein the zoom operation operates to select a zoom level with corresponding detail relating to the plurality of discovered computing entities. In another embodiment, the method further comprises an act of creating, responsive to a selection of a control, a dependency between at least two entities, wherein one of at least one of the two entities is indicated to have a dependent relationship with the other of the at least two entities, and wherein the dependency relationship is indicated as a connection within the display.

According to another aspect, an entity management system is provided comprising a discovery engine configured to discover a plurality of computing entities coupled by one or more communication networks, a mapping component adapted to represent the plurality of discovered computing entities and associated connections in a plurality of dimensions in a graphical map, and at least one user interface control that when selected, causes the interface to display at a group of connections in at least one of the least one of the plurality of dimensions. According to one embodiment, the interface is adapted to display a plurality of layers overlayed within the display.

In another embodiment, the plurality of layers are selectively displayed within the display. In another embodiment, the at least one user interface control is adapted to cause at least one of the plurality of layers to be displayed. In another embodiment, each of the plurality of layers includes respective connectivity information corresponding to connectivity within a respective one of the plurality of dimensions. In another embodiment, the each of the plurality of layers are shown as a series of overlays within the display. In another embodiment, each overlay includes connection information that identifies connections between the plurality of computer entities within an identified respective one of the plurality of dimensions.

In another embodiment, the plurality of dimensions comprises a logical connection between the plurality of computer entities, and a virtual connection between the plurality of computer entities. In another embodiment, the plurality of dimensions includes at least one of a group comprising a layer 2 connectivity dimension, a layer 3 connectivity dimension, a virtual connectivity dimension, and a wireless connectivity dimension.

According to another aspect, a non-volatile computer-readable medium encoded with instructions for execution on a computer system, the instructions when executed, provide an entity management system comprising, a discovery engine configured to discover a plurality of computing entities coupled by one or more communication networks, a mapping component adapted to represent the plurality of discovered computing entities and associated connections in a plurality of dimensions in a graphical map, and at least one user interface control that when selected, causes the interface to display at a group of connections in at least one of the least one of the plurality of dimensions.

In another embodiment, the interface is adapted to display a plurality of layers overlayed within the display. In another embodiment, the plurality of layers are selectively displayed within the display. In another embodiment, the at least one user interface control is adapted to cause at least one of the plurality of layers to be displayed. In another embodiment, each of the plurality of layers includes respective connectivity information corresponding to connectivity within a respective one of the plurality of dimensions. In another embodiment, the each of the plurality of layers are shown as a series of overlays within the display.

In another embodiment, each overlay includes connection information that identifies connections between the plurality of computer entities within an identified respective one of the plurality of dimensions. In another embodiment, the plurality of dimensions comprises a logical connection between the plurality of computer entities; and a virtual connection between the plurality of computer entities. In another embodiment, the plurality of dimensions includes at least one of a group comprising a layer 2 connectivity dimension, a layer 3 connectivity dimension, a virtual connectivity dimension, and a wireless connectivity dimension.

According to another aspect, a method is provided comprising an act of discovering, via a management system, a plurality of computing entities coupled by one or more communication networks, representing, within a display of the management system, the plurality of discovered computing entities and associated connections in a plurality of dimensions in a graphical map, and representing, within a display of the management system, a group of connections in at least one of the least one of the plurality of dimensions. According to one embodiment, the method further comprises an act of selectively displaying a plurality of layers overlayed within the display. According to another embodiment, the plurality of layers are selectively displayed within the display responsive to a user control selection.

According to another aspect, an entity management system comprising a discovery engine configured to discover a plurality of computing entities coupled by one or more communication networks, a mapping component adapted to represent the plurality of discovered computing entities and associated connections in a plurality of dimensions in a graphical map, and at least one user interface control that when selected, causes the interface to perform a zooming operation within the graphical map, wherein the zoom operation operates to select a zoom level with corresponding detail relating to the plurality of discovered computing entities.

According to another aspect, an entity management system is provided comprising a discovery engine configured to discover a plurality of computing entities coupled by one or more communication networks, a mapping component adapted to represent the plurality of discovered computing entities and associated connections in a plurality of dimensions in a graphical map, and at least one user interface control that when selected, causes the interface to create a dependency between at least two entities, wherein one of at least one of the two entities is indicated to have a dependent relationship with the other of the at least two entities, and wherein the dependency relationship is indicated as a connection within the display.

According to another aspect, an entity management system is provided comprising a discovery engine configured to discover a plurality of computing entities coupled by one or more communication networks, a mapping component adapted to represent the plurality of discovered computing entities and associated connections in a plurality of dimensions in a graphical map, and at least one user interface control that when selected, causes the management system to perform a management action on the selected subset of the plurality of discovered computing entities. According to one embodiment, the management action is at least one of a group comprising a monitor action, an application of a credential, and a grouping action.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a distributed computer system capable of implementing various aspects of the present invention;

FIG. 2 shows an example management interface according to one embodiment of the present invention;

FIG. 3 shows an example process for managing entities according to one embodiment of the present invention;

FIG. 4 shows an example process for interacting with a management system interface according to various embodiments of the present invention;

FIGS. 5A-5B shows an example detailed distributed computer system according to one embodiment of the present invention;

FIG. 6 shows another example detailed distributed computer system according various aspects of the present invention;

FIG. 7A shows an example process for processing management data according to various aspects of the present invention;

FIG. 7B shows an example process for managing credential information of an entity according to one embodiment;

FIG. 7C shows an example user interface used for viewing and interacting with discovered entities and entering credential information according to one embodiment;

FIG. 8 shows an example method for viewing network management data according to one embodiment of the present invention;

FIG. 9 shows an example map of a base network and subnet group according to one embodiment of the present invention;

FIG. 10 shows a zoomed in level 2 view including icons according to one embodiment of the present invention;

FIG. 11 shows a zoomed in level 3 view including entity names according to one embodiment of the present invention;

FIG. 12 shows a zoomed in level 4 view including larger icons and interface names according to one embodiment of the present invention;

FIG. 13 shows a group picker expanded according to one embodiment of the present invention;

FIG. 14 shows a group selected within the interface according to one embodiment of the present invention;

FIG. 15 shows a virtualization overlay applied according to one embodiment of the present invention;

FIG. 16 shows a wireless overlay applied according to one embodiment of the present invention;

FIG. 17 shows an expanded filter panel according to one embodiment of the present invention;

FIG. 18 shows input of filter text within an interface according to one embodiment of the present invention;

FIG. 19 shows the input filters applied within the interface according to one embodiment of the present invention;

FIG. 20 shows an example of a box select of entities according to one embodiment of the present invention;

FIG. 21 shows an example drag and drop of a credential according to one embodiment of the present invention;

FIG. 22 shows an example monitor drag and drop from a palette according to one embodiment of the present invention;

FIG. 23 shows an example entity card opened within the interface according to one embodiment of the present invention; and

FIG. 24 shows an example display of device dependency links according to one embodiment of the present invention.

### DETAILED DESCRIPTION

According to one implementation, a system is provided that is capable of storing and presenting within a management interface complex relationships between entities. For instance, it is appreciated that there may be complex relationships between assets such as network communication equipment, servers, desktops, applications and other assets. Further, it is appreciated that it may be helpful to record and visualize various functional aspects that these particular assets provide.

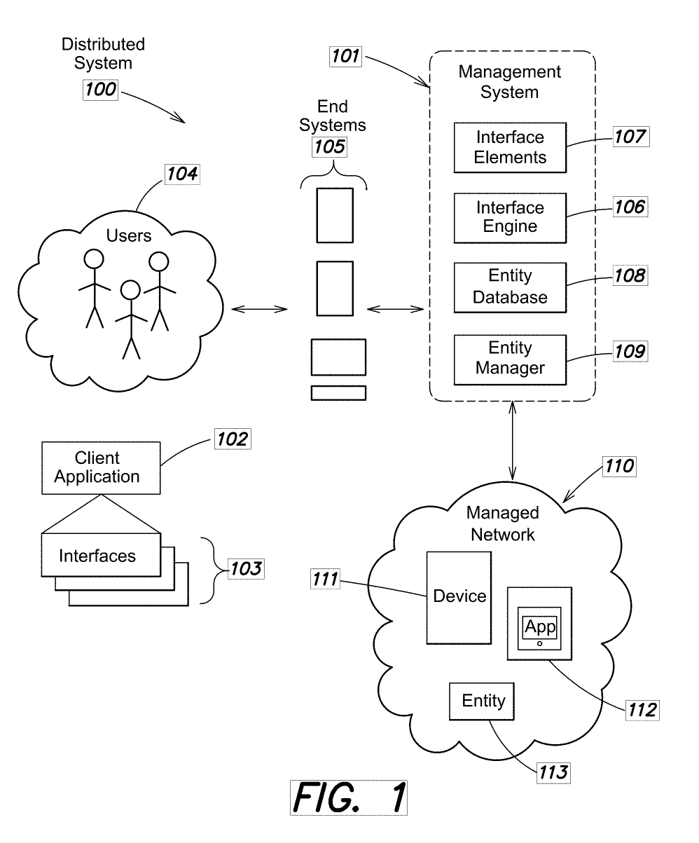

FIG. 1 shows a block diagram of a distributed computer system 100 capable of implementing various aspects of the present invention. In particular, distributed system 100 includes a management system 101 that interfaces with one or more end systems 105 operated by one or more users 104. Generally, users may access a management program through a client application 102 that is executed on one or more of end systems 105. End systems 105 may be, for example, a desktop computer system, mobile device, tablet or any other computer system having a display.

As discussed, various aspects of the present invention relate to interfaces through which the user can interact with a management system (e.g., management system 101). To this end, client application 102 may include one or more interfaces 103 through which users 104 access management system 101.

Management system 101 may include one or more components including interface elements 107 which are graphical elements and their associated underlying data that are used to represent entities within an interface display. Management system 101 may also include an interface engine 106 that processes interface actions performed by one or more users and executes associated actions within the management system. System 101 may also include an entity database 108 that stores information relating to one or more assets including network assets (e.g., network communication devices, links, or the like), server/desktop assets (e.g., end-user systems, servers, storage nodes, or other computer resource types), application assets (e.g., application services, application entities, or other service), or any other type of asset, either physical or virtual.

Management system 101 may also include an entity manager 109 that creates entities within the entity database 108 and manages communications to a managed network of actual entities, such as devices (e.g., device 111), applications (e.g., app 112), or any other entity (e.g., entity 113). Manager 109 may communicate with entities using one or more protocols, including but not limited to SNMP, WMI, TCP, ICMP, HTTP, or any other communication method or protocol.

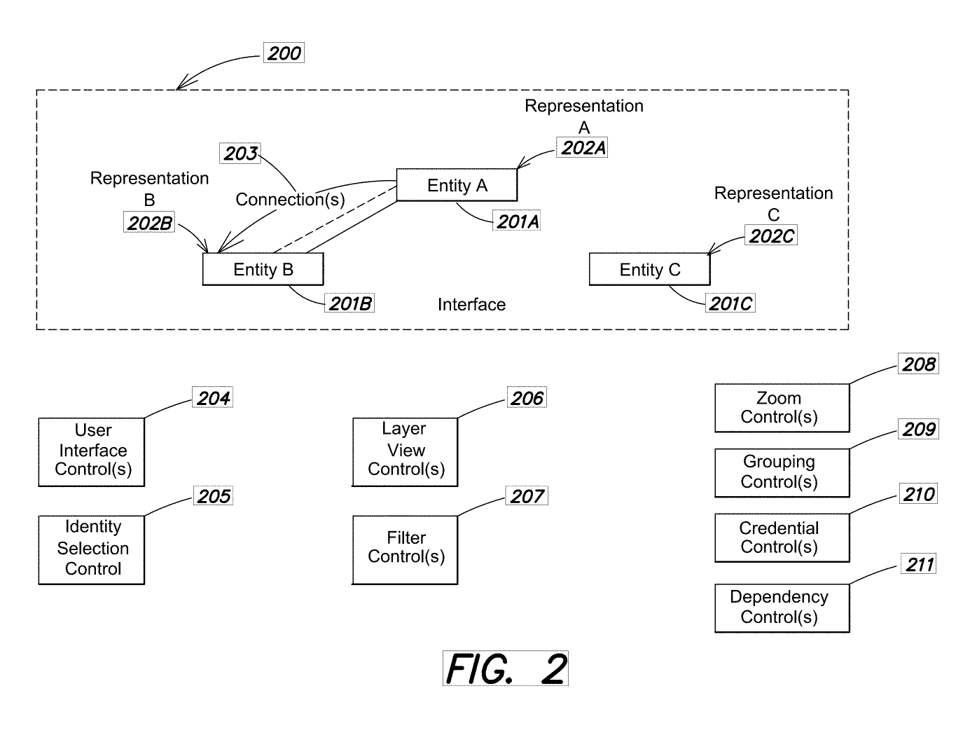

As discussed above, one aspect of the invention relates to the interface is used to manage such entities. As discussed, it is realized that many interfaces of mentoring programs are insufficient in that it takes multiple user actions and/or representations to visualize actual connectivity within a network. To this end, an interface 200 as shown by way of example in FIG. 2 is provided that includes one or more representations of entities along with their associated connections.

Although network maps with interconnected nodes are known, users are often times required to access multiple unrelated management views to get an adequate understanding of a network. According to one aspect, the singular view of entities and their connections are viewed in controlled by management user. For instance, interface 200 associated with a management system (e.g., management system 101) is provided that includes one or more representations (e.g., representations A-C (elements 202A-202C)) of entities (e.g., entities A-C (elements 201A-201C)). Entities may be displayed along with their connections (e.g., connections 203) within the interface.

Depending on the control selected, the displayed connections may be changed to permit the user to get an understanding of connectedness in the network, and to apply user actions to those managed entities. To accomplish this, the system may include one or more controls that permit the user to filter, group and apply actions to managed entities. For example, interface 200 may include one or more user interface controls (e.g., user interface control(s) 204) that permit the user to interact with the management system. One such type of control may include an identity selection control (e.g., identity selection control 205) that permits the user to select and group one or more entities within the interface.

Other controls may be provided, such as layer view controls (e.g., layer view control(s) 206) that permit the user, when selected, to view particular layers within the interface. For instance, upon selecting a layer to control, layer 2 connections between the entities displayed within the interface are shown to the user (e.g., by connectivity lines drawn between entities). In another example, a wireless network control may show wireless connections between entities. Other types of controls that show other layers of connectedness may be provided.

According to one embodiment, the system may provide one or more filter controls (e.g., filter control(s) 207) that permit the user to filter the displayed entities within the interface. For instance, by default, the system may display all entities that are discovered throughout the network. The system may include an input (e.g., a text box) that permits the user to limit the number of entities that are displayed to the management user to aid in display of those entities matching criteria (e.g., a search parameter) and to perform management actions associated with such criteria.

In another embodiment, the system may provide one or more zoom controls (e.g., zoom control(s) 208), that permit the user to zoom in or zoom out of the various levels of detail presented within the interface. For instance, in a default configuration, discovered entities may be represented by small icons connected by their recognized connections. The user may use a control (e.g., a menu selection, and interface control, or other control (e.g., a scroll feature on the mouse)) to transition between various levels of zoom information. As discussed, according to one embodiment, a first level of zoomed information may include a highest level of detail showing various entities represented graphically as nodes and their interconnectedness. A next level may show an entity type of particular entities (e.g., as represented by icons of a particular style (e.g., a device type)). A further more detailed level may include the names of the entity (e.g., a device name) and a last zoom level may include the interface names associated with the device.

In another embodiment, the system may provide one or more grouping controls (e.g., grouping control(s) 209) that permit the user to group entities and perform actions on selected groups of entities. For example, the control may include a keyboard or mouse input that selects multiple entities within a group. The system and interface may permit certain controls to be applied to those groups (e.g., through a drag-and-drop action that drags an action onto the selected group). For instance, the system may include a credential control that permits a user to apply a credential to a particular entity or groups of entities (e.g., as selected through a grouping action).

Further, system 101 may also include one or more dependency controls (e.g., dependency control(s) 211) that permit the system or the user to identify dependencies between entities displayed within the interface. For example, the system may include a drawing tool that allows a user to draw a line from a source entity to a target entity. In one embodiment, the nature of the dependency is directional in that the target entity will inherit the status or other information from the source entity. This may be useful, for instance, when identifying downstream entities that have some communication dependency to an upstream entity.

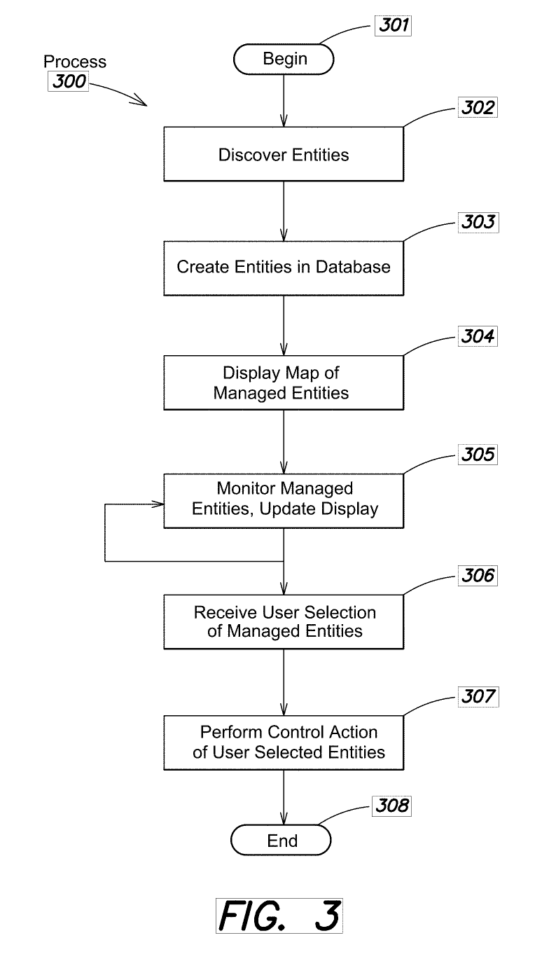

FIG. 3 shows an example process 300 for managing entities by a management system according to one embodiment of the present invention. At block 301, process 300 begins. At block 302, the system (e.g. management system 101) discovers entities within a managed network (e.g., managed network 110). This may be accomplished using a discovery process using one or more management protocols. At block 303, the system creates one or more entities within a database (e.g. within entity database 108).

At block 304, the system displays a map of all the managed entities that were discovered by the management system 101. At block 305, the system monitors the manage entities and updates the display of those entities as appropriate. Such monitoring may continue indefinitely as entities are discovered, maps updated, and entities are monitored.

According to one aspect of the present invention, a user (e.g. a management system user) interacts with the system to perform one or more management actions. As discussed above, the user interface is provided that permits the user to more easily perform management actions. Using the controls provided, the user is allowed to easily select and locate particular entities (e.g., at block 306) and to perform control actions of user selected entities at block 307. At block 308, process 300 ends.

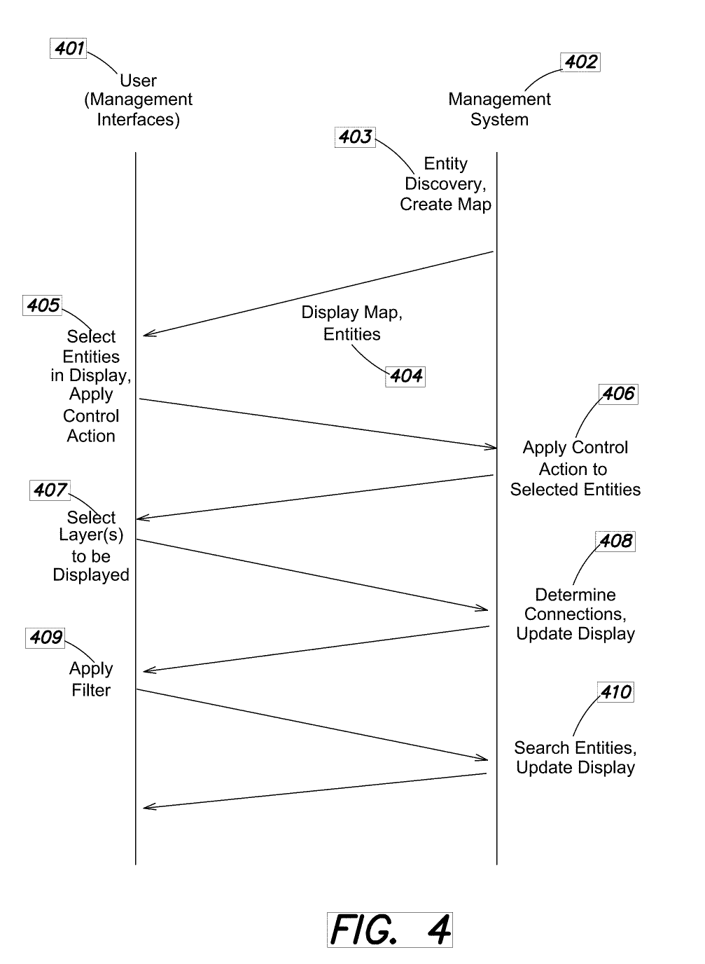

FIG. 4 shows example processes for interacting with a management system interface according to various embodiments of the present invention. More particularly, FIG. 4 shows an example communications that may exist between a user operating one or more management interfaces at an end user system (e.g., element 401) and a management system 402. At 403, the management system performs an entity discovery and creates a map as discussed above with reference to FIG. 3. System 402 creates a entity database and a representation of a display map at 404. At 405, a user, within the interface, selects entities in the display. The user then selects and implies a particular control action to those selected entities. For instance, as discussed, the user may select a credential control and apply that set of credentials to a group of selected entities (e.g., at 406).

In another action, the user may select one or more layers to be displayed within the interface. For instance, this may be accomplished using one or more tools such as a layer view control that selectively displays connectivity between the entities relating to particular layer (e.g., layer 2, layer 3, wireless, or other type of connectivity). Depending on the type of leader view control selected, the management system made determine (e.g., at 408) connections between the entities associated with the selected layer control and the display may be updated and shown to user.

In another action type, the user may provide an input and apply a filter (e.g., at 409) which functions as the search of the entity database. At 410, management system 402 searches the entities associated with parameters provided by the filter and updates the display which is subsequently displayed to the user. In this way, users may be provided a more efficient method for operating the interface through a series of searching, grouping, and performing control actions.

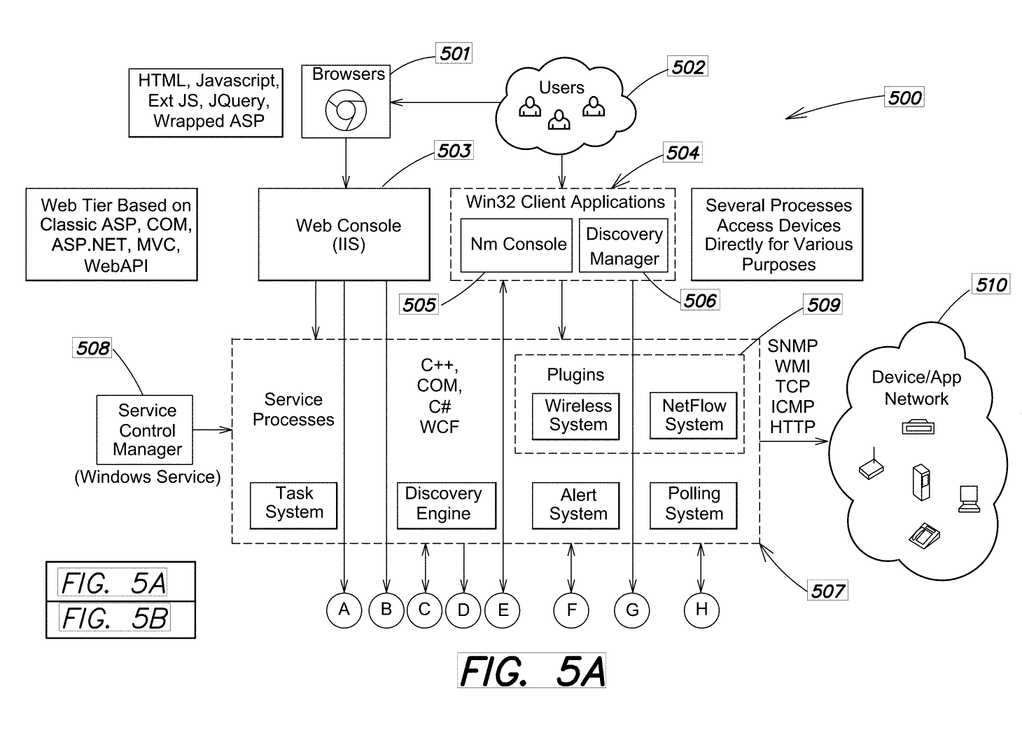

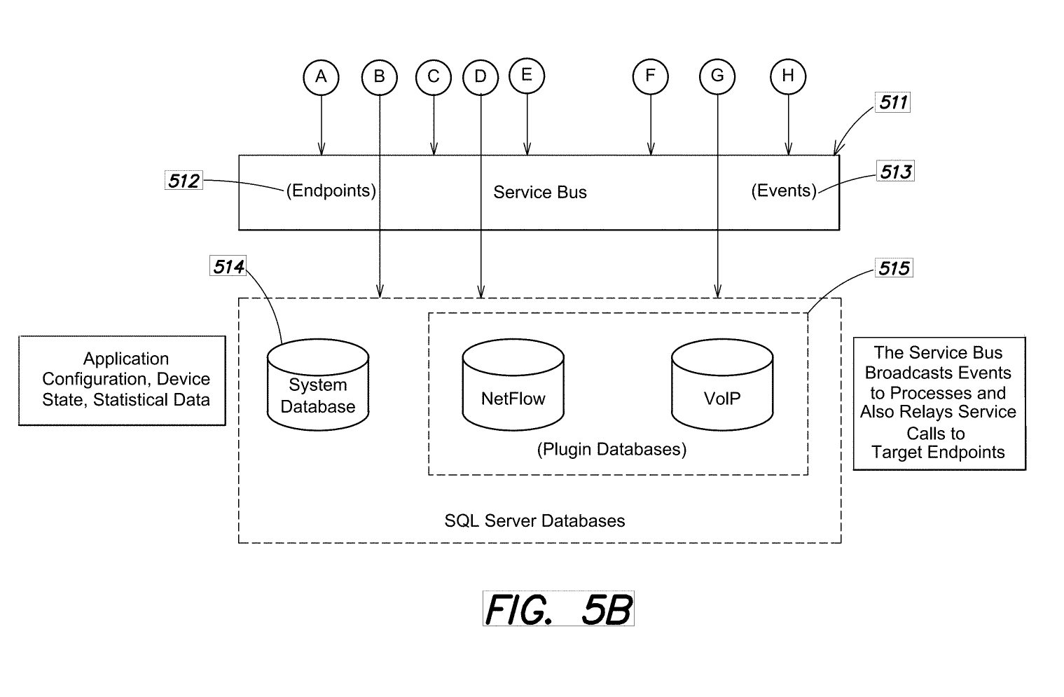

FIGS. 5A-5B show an example detailed distributed computer system according to one embodiment of the present invention. More particularly, FIGS. 5A-5B show a management system (e.g., management system 101) implemented as a Windows service that has one or more users that access it. For instance, users (e.g., users 502) may access the Windows service (e.g., one or more Windows services) through web browsers (e.g., web browsers 501) that communicate with a web console function 503. Users may operate one or more client applications (e.g., Win32 client applications 504) such as an NM Colsole application 505 that presents and interacts with a user to perform one or more management functions. The system may also include a discovery management application 506 that is capable of discovering one or more managed entities in a device/application network 510.

The system may have a number of service processes 507 such as a discovery engine that discovers, using one or more protocols, the device/application network. The system may perform other functions such as, for example, alerting management users, pulling devices for status, obtaining performance statistics, communicate events (e.g., events 513) and endpoint data (e.g., via endpoints 512), among other functions. Such functions may be performed using several processes that execute and access devices/entities for various purposes. The system may include a service bus 511 that allows processes to communicate (e.g., events, service calls, etc.) and to communicate with one or more databases such as the system database 514 which includes managed entities, plugin databases (515) such as a data flow database (e.g., NetFlow), VoIP database, among others. Such databases may include one or more native databases and any number of plugin database types.

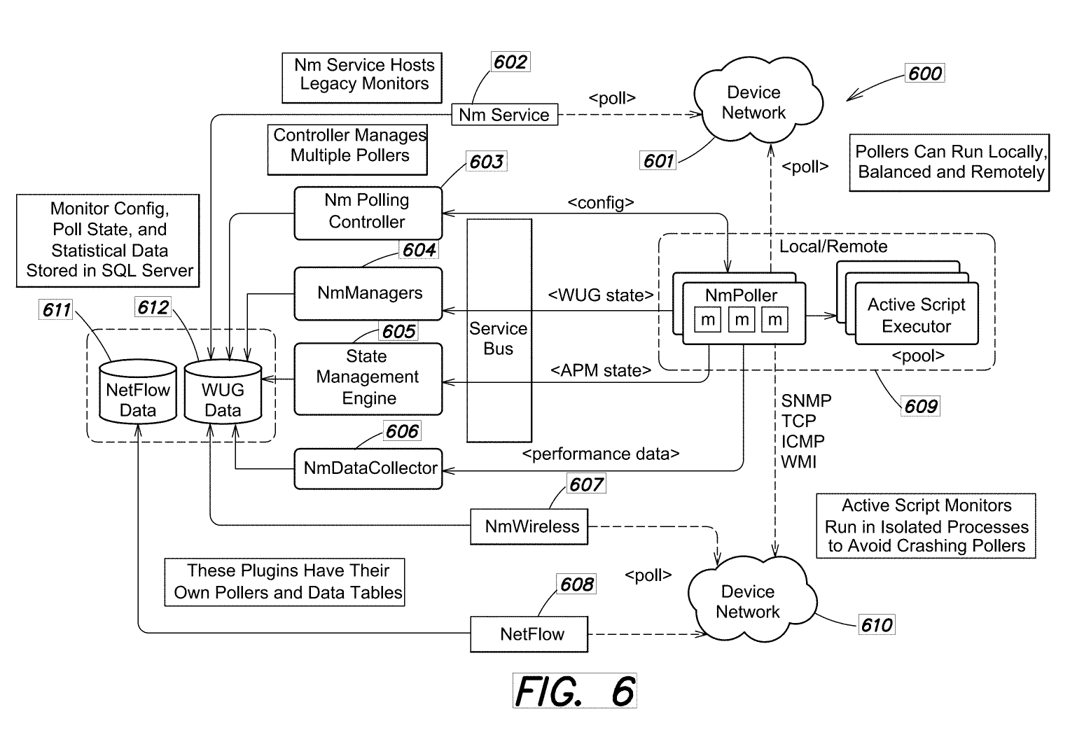

FIG. 6 shows another example detailed distributed computer system 600 according various aspects of the present invention. For example, FIG. 6 shows how one or more service processes and/or subsystems that perform polling, configuration, state management, performance data management, polling, etc. communicate among entities within the management system (e.g., system 101) to manage a device network 601, 610. There are some pollers that work locally to a host (e.g., a client system), some pollers are specific to the function being performed (e.g., wireless polling), and some pollers collaborate with other processes to accomplish monitoring functions (e.g., Nm Pollers). A polling controller may be provided that sends monitor/collector configurations to generic pollers so that they can poll in the manner necessary. Further, components may be provided that perform end user monitoring, and report to the management system.

In particular, system 600 may include am Nm Service that hosts legacy monitors that poll a device network (e.g., device network 601). A legacy polling process or “poller” may be characterized by a process that executes at the management system (e.g., a host that runs a management application). The legacy poller may also run as a single instance and may be self-contained, accessing local databases, and performing both active and passive monitoring. System 600 may also include a controller (e.g., Nm polling controller 603) that is adapted to send configurations to multiple polling processes or “pollers” so that they can perform their functions. An NmManager 604 service may be provided that monitors and manages multiple polling processes. Such processes (e.g., local remote processes 609) may be local to the management system or be remote management functions (e.g., such as those executed on other systems by scripts or other applications)).

System 600 may include other poller types that handle different types of entities and/or data. For instance, the NmWireless poller may handle collecting wireless entity information (e.g., such as wireless states).

Also, multiple processes and services may be capable of storing information in one or more databases, such as database 611 which stores flow information (e.g., NetFlow data acquired by a NetFlow polling entity 608), or a systems management database associated with managing entities within the network (e.g., a system-level entity management database, shown in FIG. 6 as WUG data 612). Each service may include their own processes and data tables.

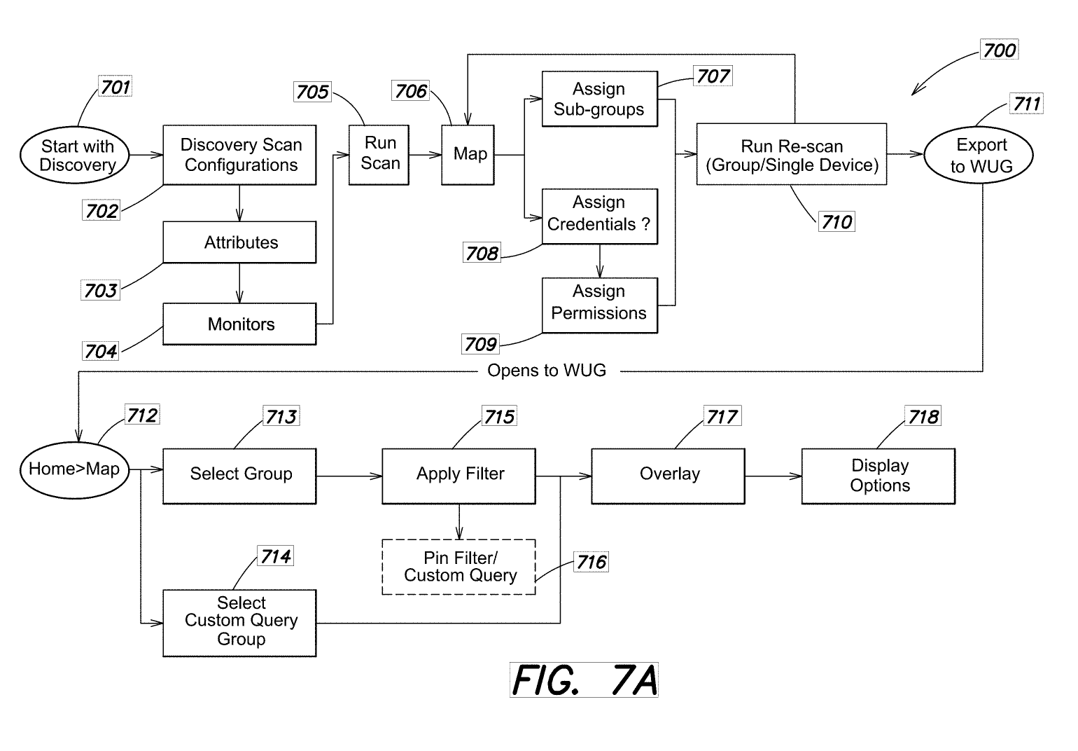

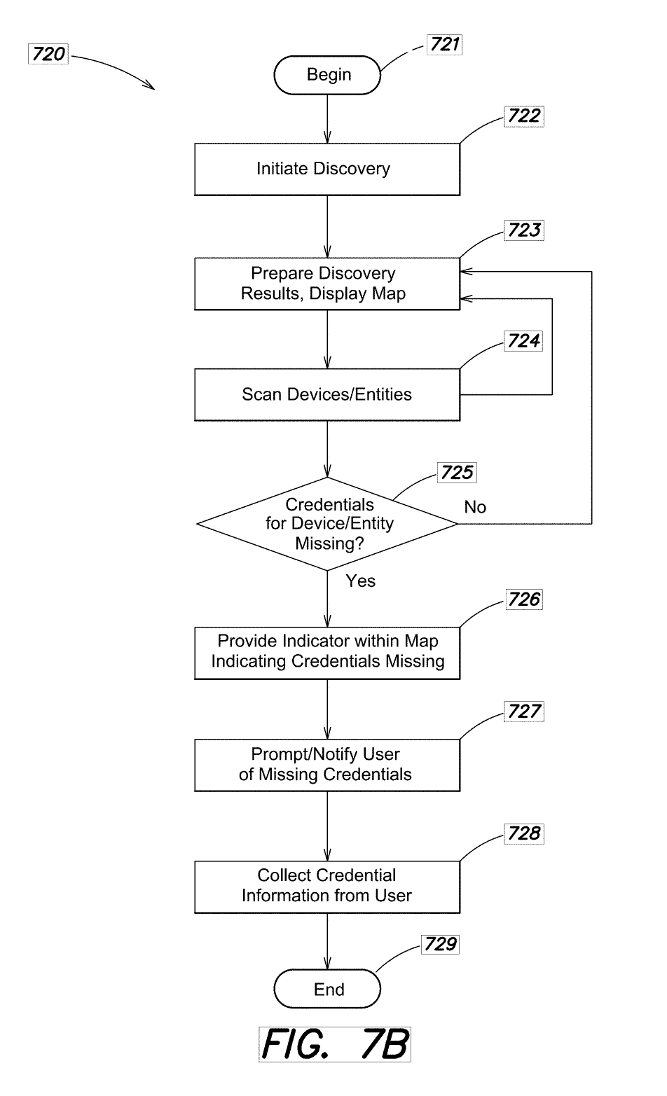

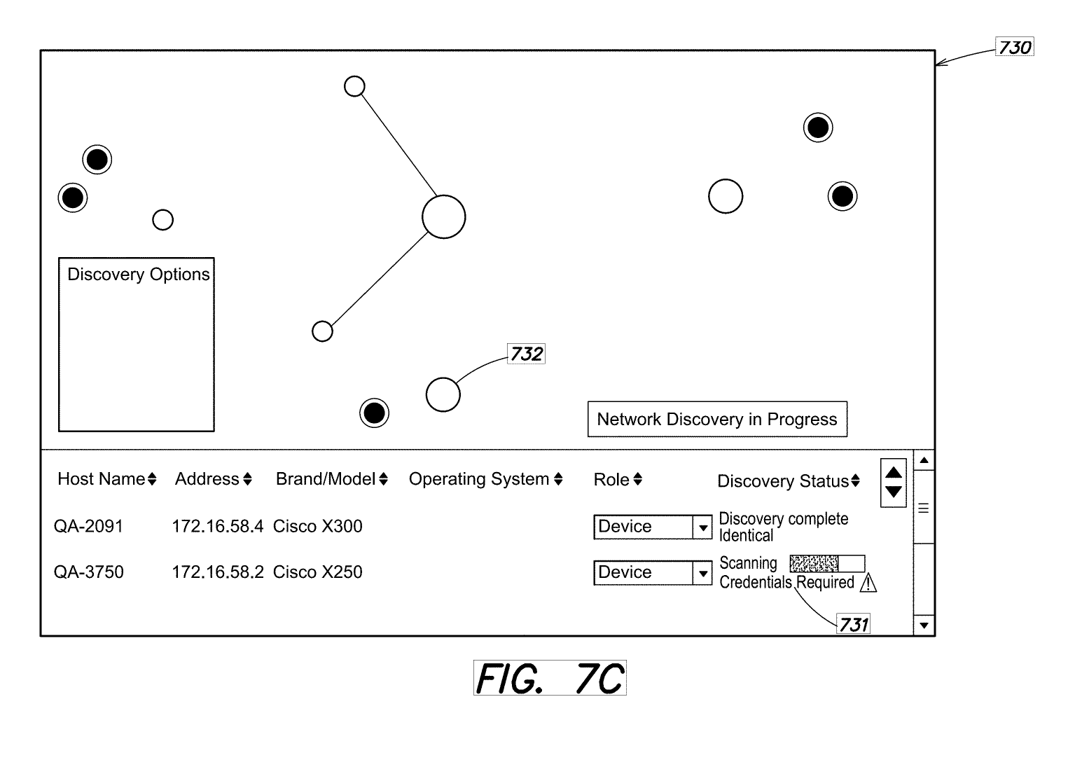

FIG. 7A shows an example process 700 for processing management data according to various aspects of the present invention. For example, as shown in the top portion of FIG. 7, the management system (e.g., system 101) may begin with a discovery process (e.g., at 701). In one embodiment, the system may employ a number of discovery scan configurations 702 to gather attributes 703 associated with particular entities. These configurations may be used to activate distributed poller processes that collect information from entities. Further, depending on the asset type, a number of different monitors 704 may be used to periodically monitor entities. As a result of determining the particular network entities and their connections (e.g., from a scan of the database such as at 705), a map may be constructed (e.g., at 706).

Once a map is constructed, and entities are determined along with their connections, parameters, and other information, they may be assigned to subgroups (e.g., at 707), credentials may be assigned (e.g., at 708), and if necessary, permissions assigned at 709. At any point, groups and/or individual entities may be rescanned (e.g., after their permissions are entered) to obtain a more complete set of information. When created, the data may be exported to a management system (e.g., (herein termed WhatsUp Gold (or WUG) at 711) where it may be visualized, such as in map form.

At 712, the management system (e.g., WUG) may open a map display oriented on a home map, and one or more managed entities are displayed, along with their connection information. After the map is displayed, the user may selectively display groups (e.g., by activating a selection control to select a group at 713), activate filters (e.g., to isolate certain entities having particular characteristics by applying a filter 715, which could be, in one example, a custom query created by a user 716). Custom filers may also be saved or “pinned.” Further, a user may create a custom query group at 715 which is a selected group of entities which a query may be applied. Further, the user may control the display of overlay data at 717, along with activation of other display options at 718.

Entities may be assigned to subgroups, credentials may be assigned as well as permissions. Scans may be re-run (e.g., periodically) to improve the database and rescan after permission changes, changes in entity configuration, entity locations, etc. The resulting map may be exported to a management application for use by a user (e.g., an IT manager). The map may be displayed to a user as a map of entities in the network along with their connection data.

As discussed, a user may be permitted to select a group of entities within the interface and perform some consolidated action on the group. Further, the user may be permitted to apply filters and save them (e.g., by creating custom queries). The user may be permitted to select one or more overlays in order to view connection information. The user may also be permitted to use one or more display options such as zooming, creating/viewing dependencies, performing one or more control actions regarding to the selected group, among other functions. In this way, a user-friendly interface is provided that reduces the amount of steps required to perform complex actions involving multiple entities.

FIG. 7B shows an example process 720 used to discovery devices according to one embodiment. At block 721, process 720 begins. At block 722, the management system initiates a discovery process, such as by invoking a discovery service. At block 723, the management system prepares discovery results, and displays a map representation.

At block 724, the management system scans devices and other entities and store the scanned information within the database. At block 725, the system determines whether credentials for any devices are missing. If so, at block 726, the system provides an indicator (e.g., a color, icon type, or other indication) that indicates that credentials are missing for a particular entity. At 727, the system may optionally prompt or otherwise notify the user of the missing credentials. At 728, the system may provide a control input that permit the user to provide credential information, or may otherwise collect credential information from the user. At block 729, process 720 ends.

FIG. 7C shows an example interface 730 that depicts results of a discovery operation according to one embodiment. As shown, the management system discovers and displays entities in a map representation within the display. As discussed, the system may be capable of providing an indication to the user that credentials may be necessary to discover more specific information relating to a particular indicated entity (e.g., as by indication 731). The management system may prompt the user within the UI to provide such information. The user interface may also have visual controls that permit a user to apply user-supplied credentials to a group of entities (e.g., a group of router nodes).

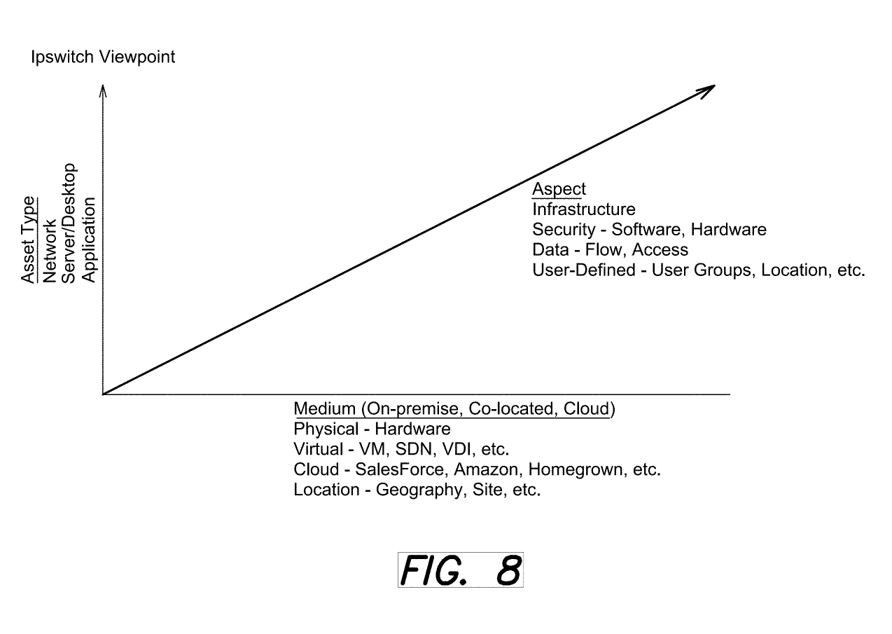

FIG. 8 shows an example method for viewing network management data according to one embodiment of the present invention. In particular, as discussed above, information may be viewed in three dimensions such as by asset type, along with the medium used, as well as the aspect that the asset belongs. By displaying information to the user in relation to these dimensions, a user may obtain a true understanding of the impact of a particular asset on the user.

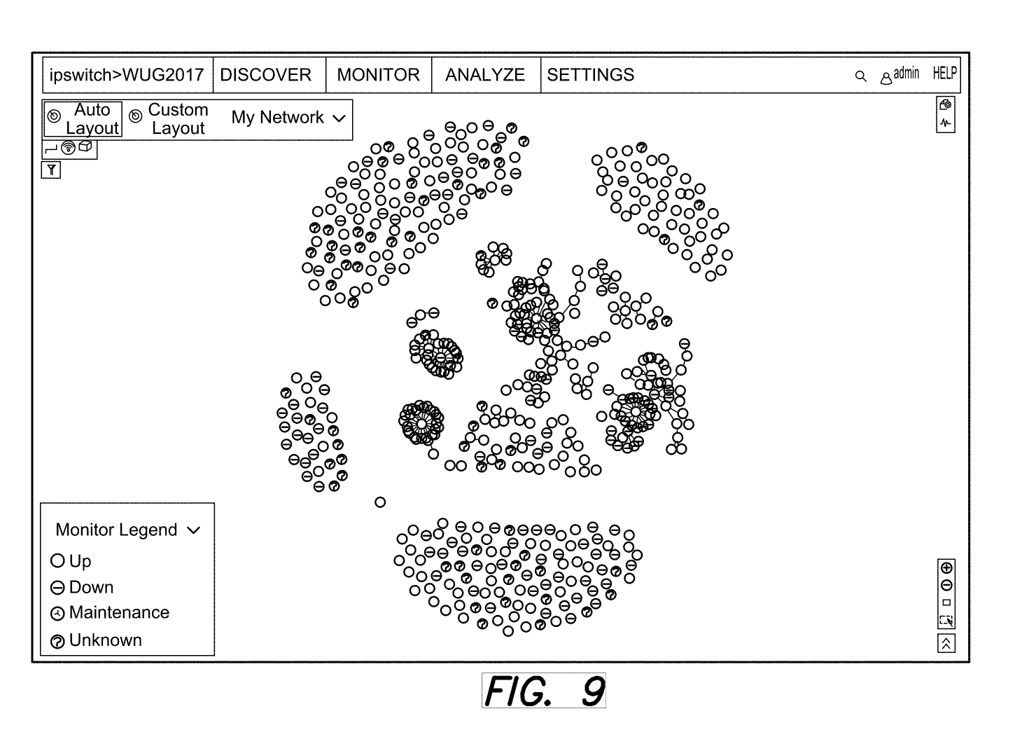

FIG. 9 shows an example map of a base network and subnet group according to one embodiment of the present invention. In particular, FIG. 9 shows an example display of a number of network entities, some of which have recognized connections and/or groupings (e.g., subnet groupings).

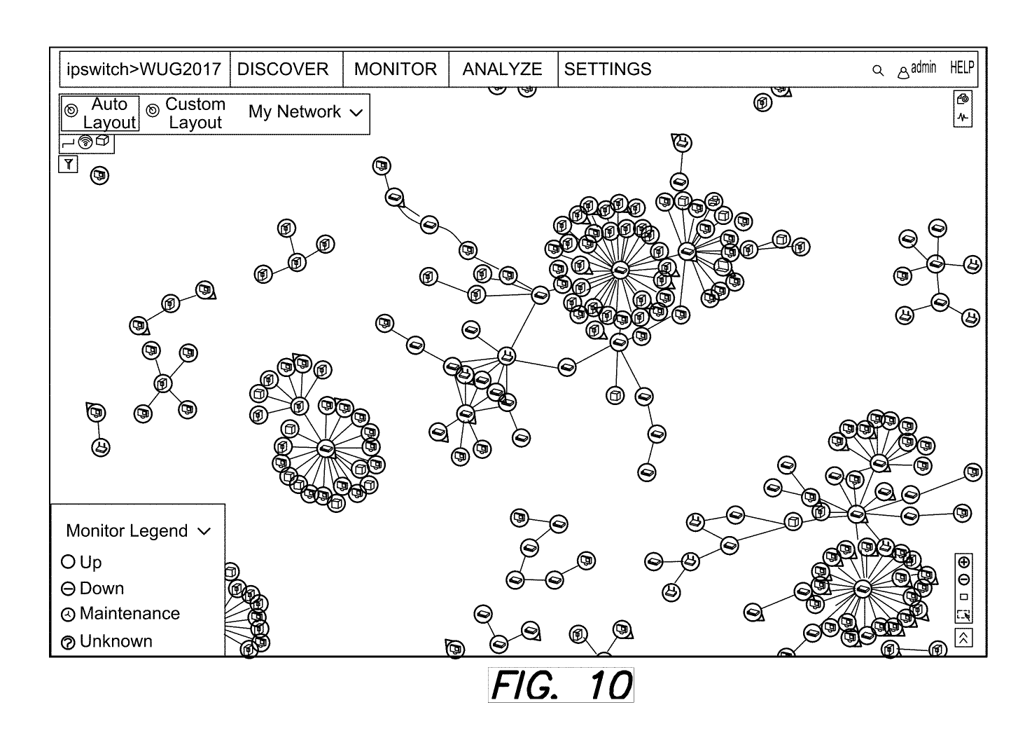

FIG. 10 shows a zoomed in level 2 view including icons according to one embodiment of the present invention. As discussed above, the user may activate a zoom control (e.g., a mouse scroll wheel) that causes the interface to show additional detail. Here in the level 2 view, icons that indicate the entity type can be seen within the interface.

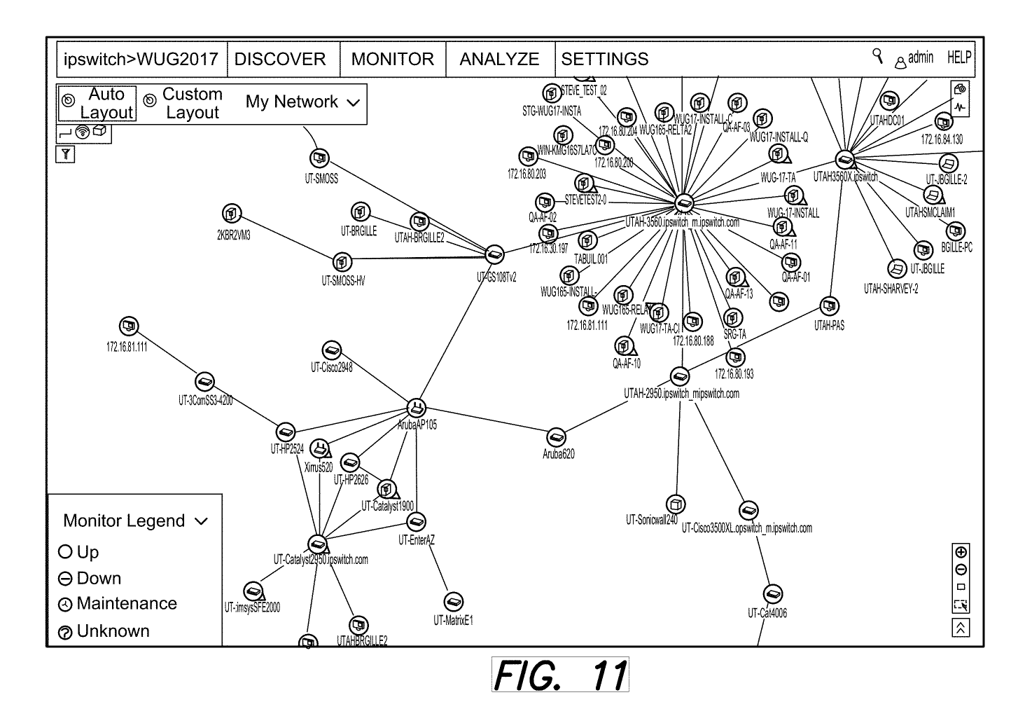

FIG. 11 shows a zoomed in level 3 view including entity names according to one embodiment of the present invention. In particular, responsive to a further zoom input, the interface shows additional detains, including the names of particular entities within the map.

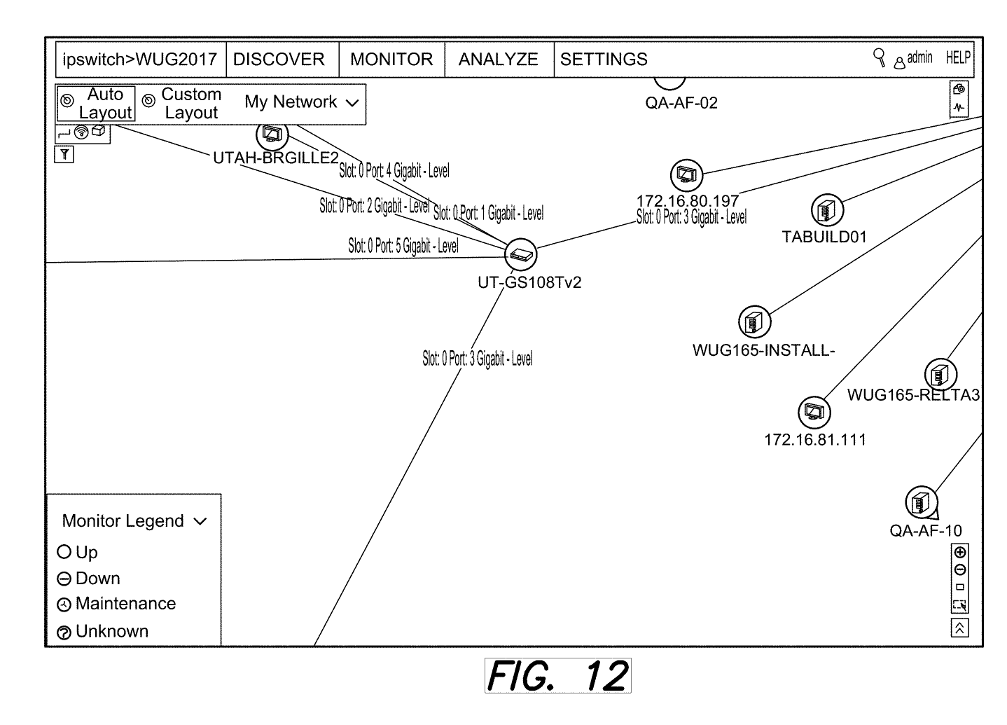

FIG. 12 shows a zoomed in level 4 view including larger icons and interface names according to one embodiment of the present invention. Here, in a further level of zoom, the interface shows the network interface names of the connected entities.

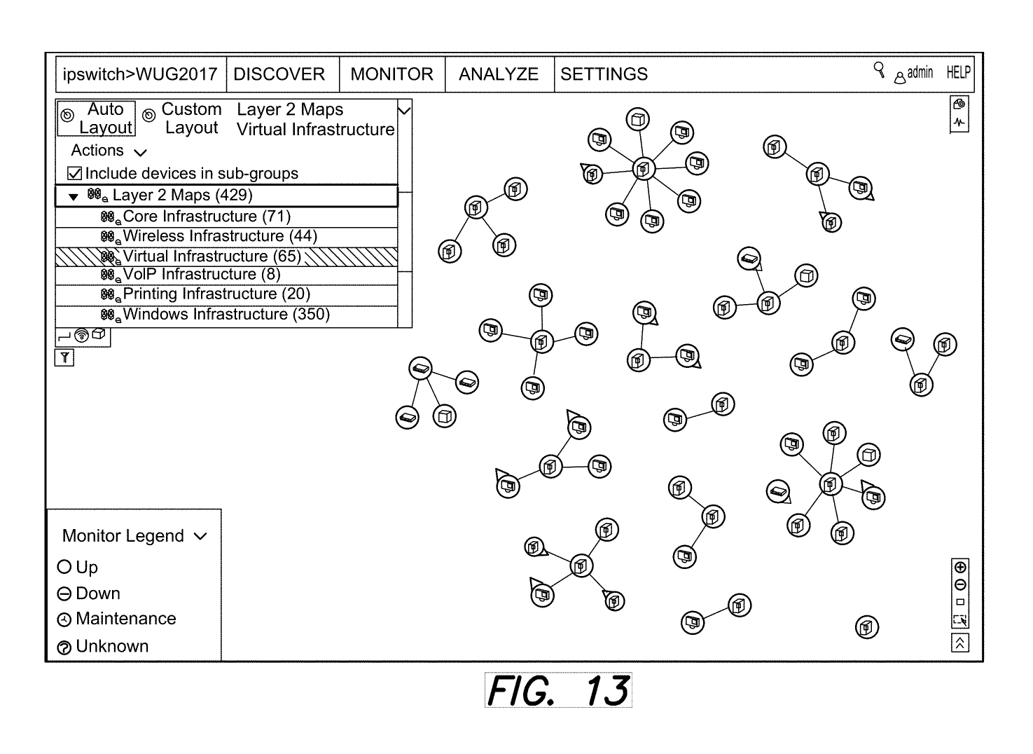

FIG. 13 shows a group picker expanded according to one embodiment of the present invention. As shown, certain defined groups may appear in a dropdown menu (e.g., Core Infrastructure, Wireless Infrastructure, Virtual Infrastructure, etc.) which correspond to particular searches being performed on the entity database, and a resultant display on the map with their associated connections.

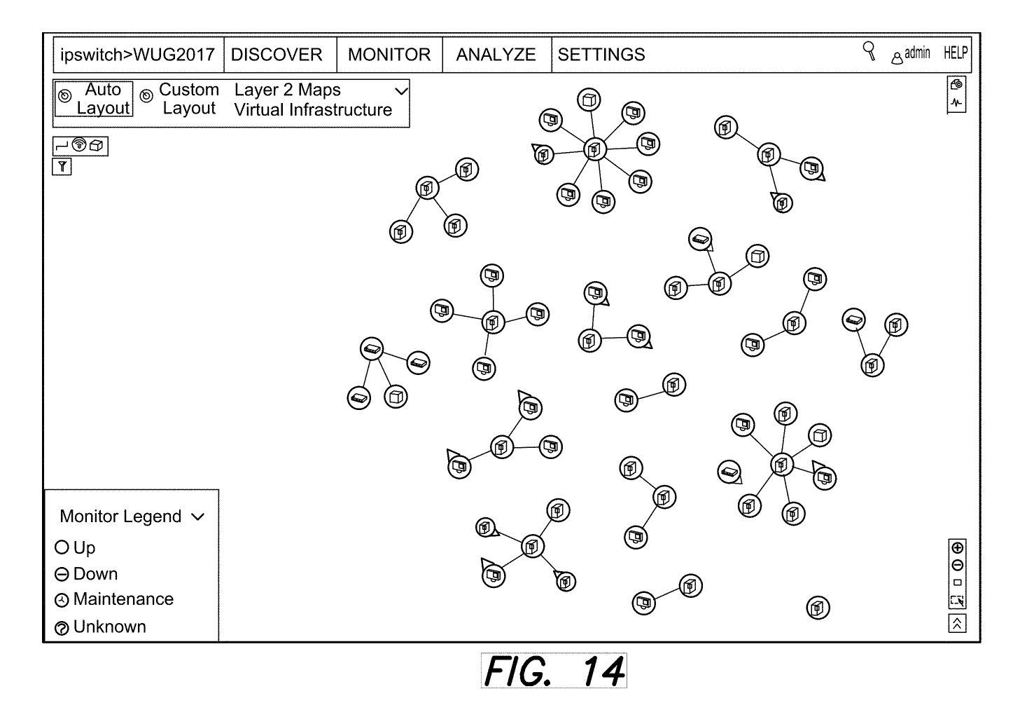

FIG. 14 shows a group selected within the interface according to one embodiment of the present invention. In particular, the Virtual Infrastructure is shown.

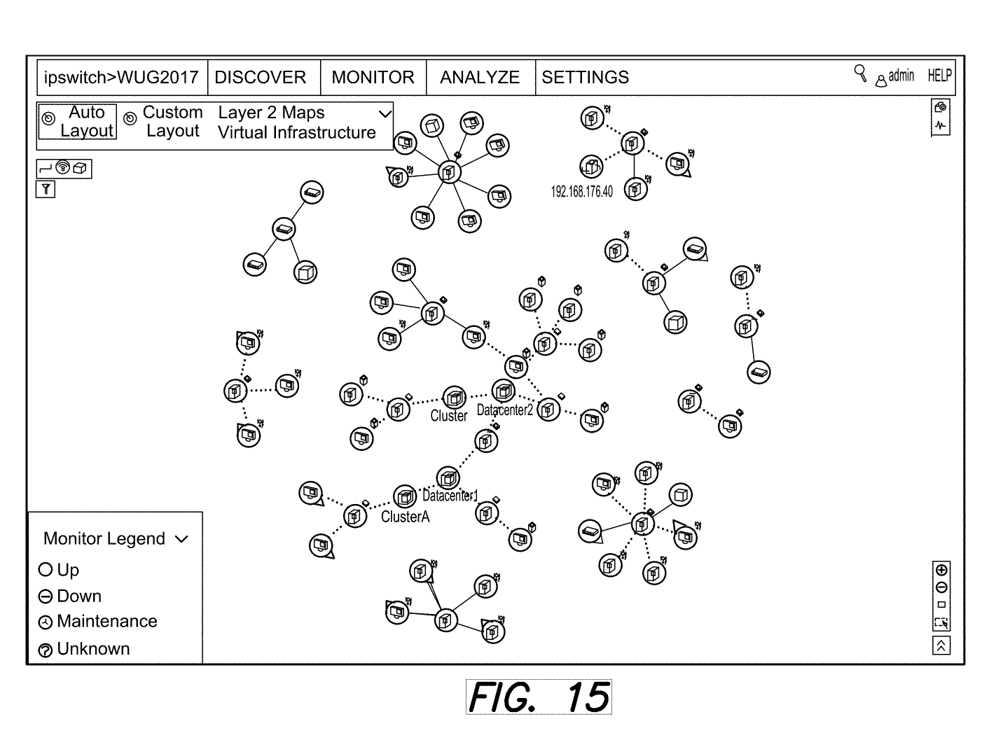

FIG. 15 shows a virtualization overlay applied according to one embodiment of the present invention. That is, the virtual overlay option was selected within the display, and the virtual connections are shown within the interface.

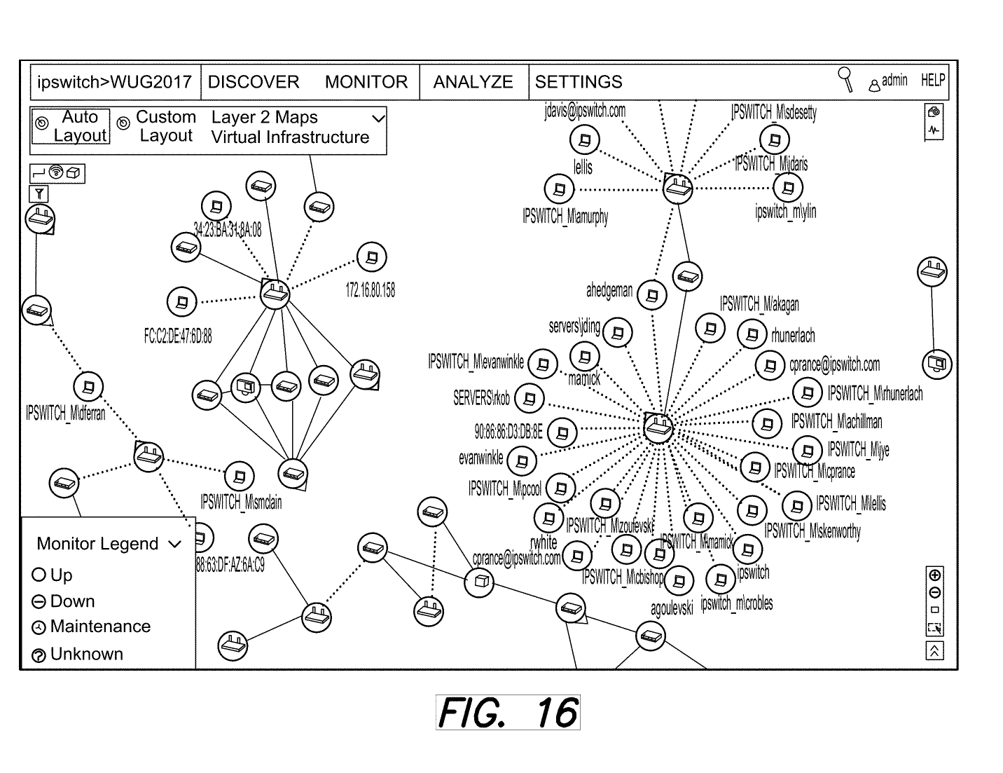

FIG. 16 shows a wireless overlay applied according to one embodiment of the present invention. That is, the wireless overlay option was selected within the display, and the wireless connections are shown within the interface.

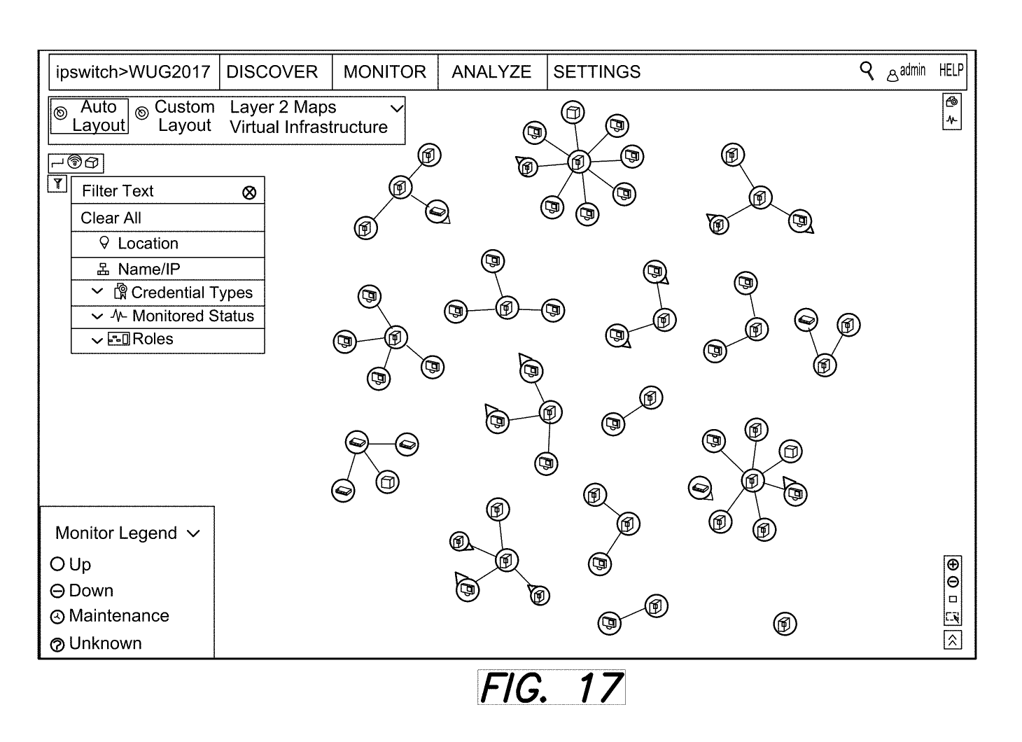

FIG. 17 shows an expanded filter panel according to one embodiment of the present invention. In particular, a text entry box may be provided that accepts search parameters from a user.

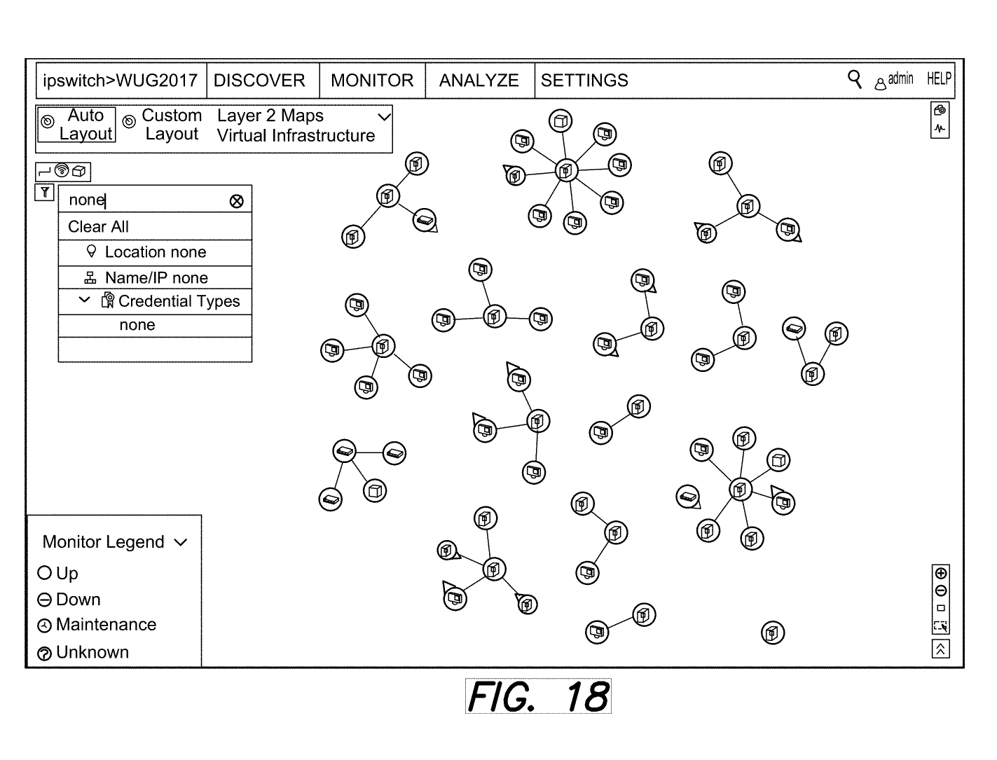

FIG. 18 shows input of filter text within an interface according to one embodiment of the present invention. In particular, the user enters actual text (e.g., “none”) that is used to search the entity database.

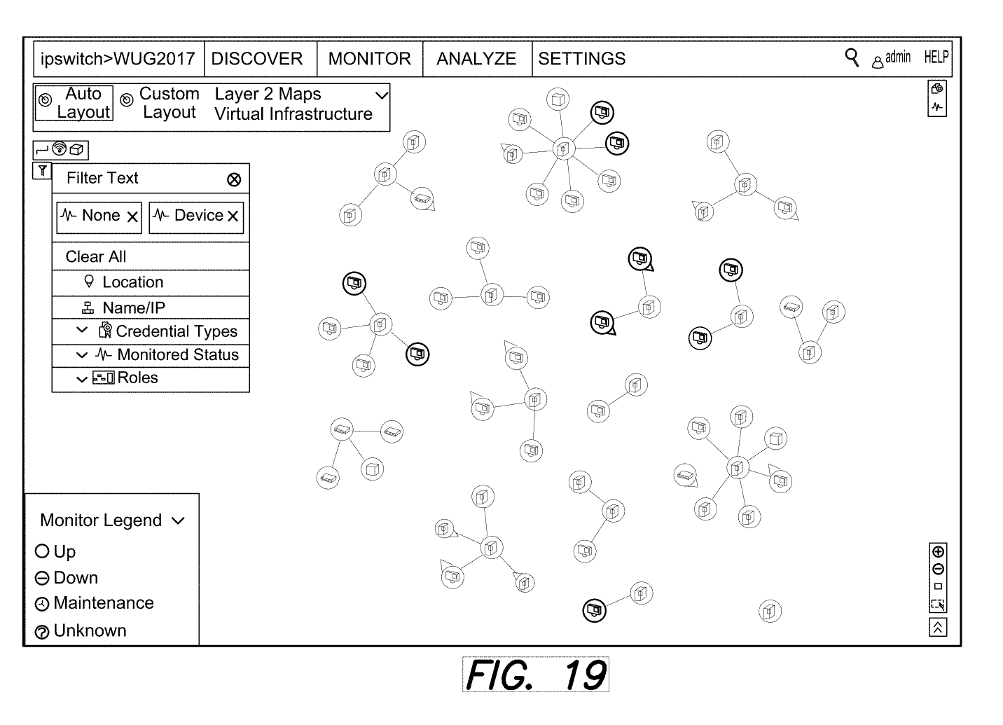

FIG. 19 shows the input filters applied within the interface according to one embodiment of the present invention. When the filter is applied, entities matching the search criteria can be seen within the interface.

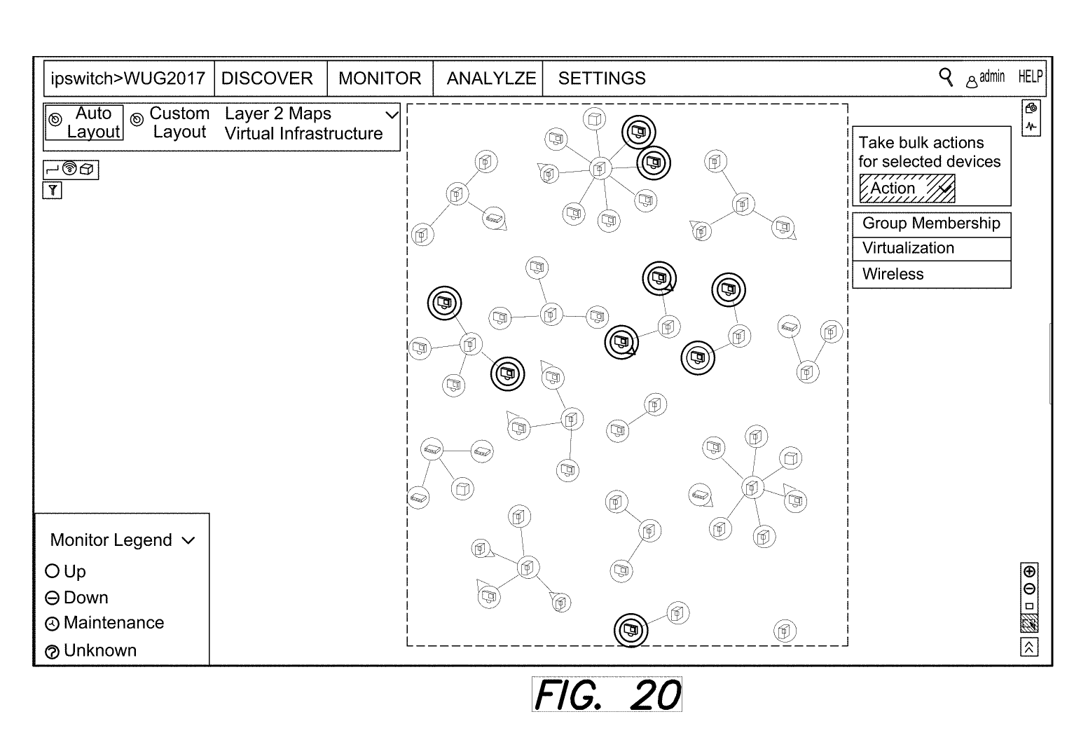

FIG. 20 shows an example of a box select of entities according to one embodiment of the present invention. In particular, the user may select, via a box selection tool, one or more entities within the map.

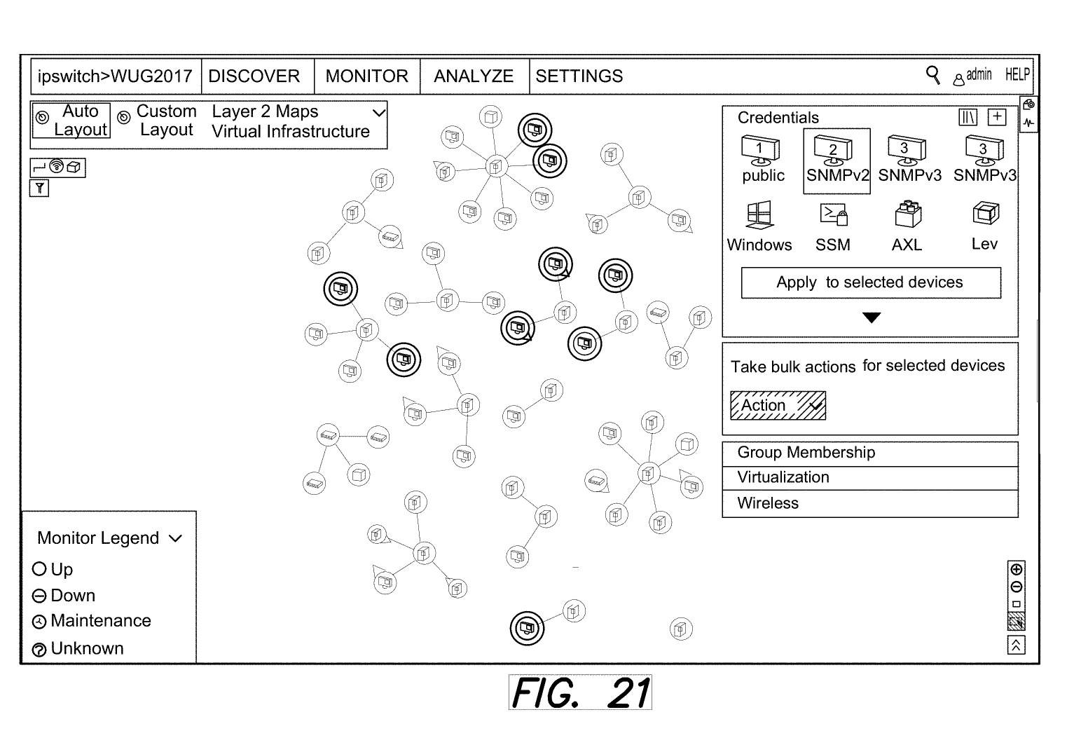

FIG. 21 shows an example drag and drop of a credential according to one embodiment of the present invention. As shown, a palette of credentials may include representations of certain credential types that can be applied to entities within the map.

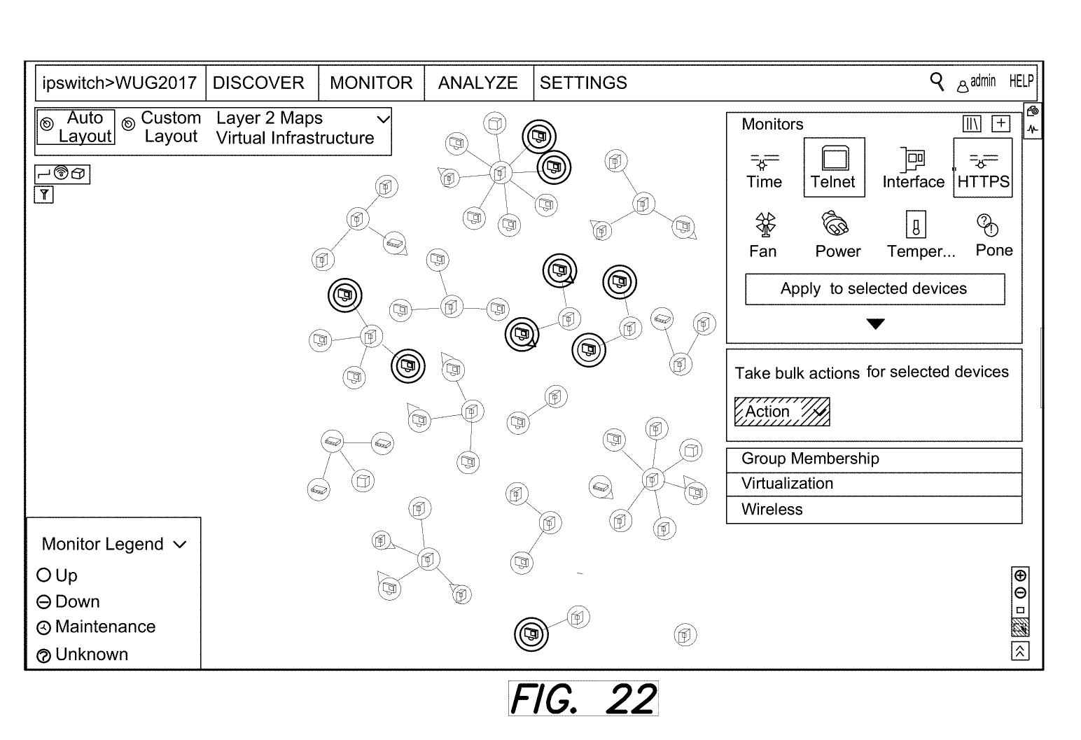

FIG. 22 shows an example monitor drag and drop from a palette according to one embodiment of the present invention. Particular selected credentials may be “dragged and dropped” onto one or more entities within the map.

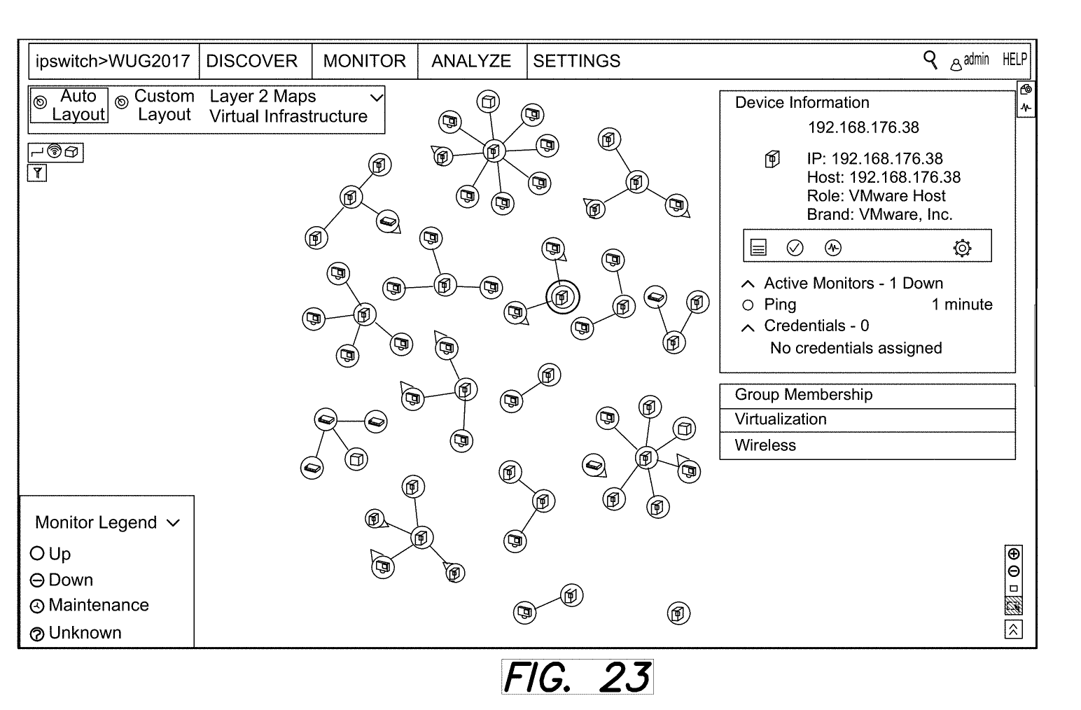

FIG. 23 shows an example entity card opened within the interface according to one embodiment of the present invention. In particular, an entity (e.g., a device) within the map view may be selected, and a control that permits the “card” to be viewed within the interface can be selected. Upon selection, parameters and settings associated with the particular entity may be viewed and/or changed.

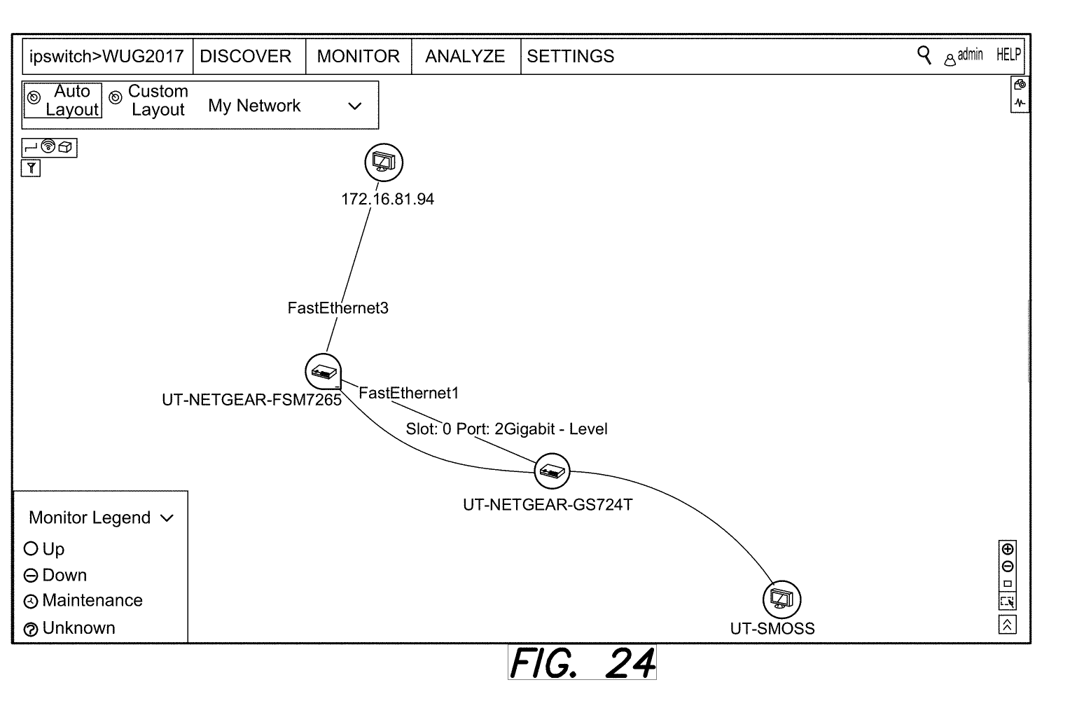

FIG. 24 shows an example display of device dependency links according to one embodiment of the present invention. For example, the curved line indicating a dependency relation may be input by a user within the interface. The dependency may be unidirectional (e.g., one entity inherits state from another entity), and thus an interface tool may be provided (e.g., a drawing tool) that allows the user to create the dependency relation within the interface.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An entity management system comprising:
a discovery engine configured to discover a plurality of computing entities coupled by one or more communication networks;
a mapping component adapted to represent the plurality of discovered computing entities and associated connections in a plurality of dimensions in a graphical map; and
an interface configured to represent the plurality of discovered computing entities and their connections in the plurality of dimensions within a single end user display.

2. The system according to claim 1, wherein the system further comprises at least one user interface control that when selected, causes the interface to display at a group of connections in at least one of the least one of the plurality of dimensions.

3. The system according to claim 1, wherein the system further comprises at least one user interface control that when selected, causes the interface to perform a zooming operation within the graphical map, wherein the zoom operation operates to select a zoom level with corresponding detail relating to the plurality of discovered computing entities.

4. The system according to claim 1, wherein the system further comprises at least one user interface control that when selected, causes the interface to create a dependency between at least two entities, wherein one of at least one of the two entities is indicated to have a dependent relationship with the other of the at least two entities, and wherein the dependency relationship is indicated as a connection within the display.

5. The system according to claim 1, wherein the system further comprises at least one user interface control that when selected, causes the interface to group at least a subset of the plurality of discovered computing entities.

6. The system according to claim 5, wherein the system further comprises at least one user interface control that when selected, causes the management system to perform a management action on the selected subset of the plurality of discovered computing entities.

7. The system according to claim 6, wherein the management action is at least one of a group comprising a monitor action, an application of a credential, and a grouping action.

8. The system according to claim 1, wherein the system further comprises at least one user interface control that when selected, causes the interface to filter the plurality of discovered computing entities.

9. The system according to claim 8, wherein the at least one user interface control comprises an input, and wherein the system accepts a user input that causes the interface to filter the plurality of discovered computing entities, and to display a filtered map of discovered computing entities that match the user input.

10. A non-volatile computer-readable medium encoded with instructions for execution on a computer system, the instructions when executed, provide an entity management system comprising:
a discovery engine configured to discover a plurality of computing entities coupled by one or more communication networks;
a mapping component adapted to represent the plurality of discovered computing entities and associated connections in a plurality of dimensions in a graphical map; and
an interface configured to represent the plurality of discovered computing entities and their connections in the plurality of dimensions within a single end user display.

11. The computer-readable medium according to claim 10, wherein the system further comprises at least one user interface control that when selected, causes the interface to display at a group of connections in at least one of the least one of the plurality of dimensions.

12. The computer-readable medium according to claim 10, wherein the system further comprises at least one user interface control that when selected, causes the interface to perform a zooming operation within the graphical map, wherein the zoom operation operates to select a zoom level with corresponding detail relating to the plurality of discovered computing entities.

13. The computer-readable medium according to claim 10, wherein the system further comprises at least one user interface control that when selected, causes the interface to create a dependency between at least two entities, wherein one of at least one of the two entities is indicated to have a dependent relationship with the other of the at least two entities, and wherein the dependency relationship is indicated as a connection within the display.

14. The computer-readable medium according to claim 10, wherein the system further comprises at least one user interface control that when selected, causes the interface to group at least a subset of the plurality of discovered computing entities.

15. The computer-readable medium according to claim 14, wherein the system further comprises at least one user interface control that when selected, causes the management system to perform a management action on the selected subset of the plurality of discovered computing entities.

16. The computer-readable medium according to claim 15, wherein the management action is at least one of a group comprising a monitor action, an application of a credential, and a grouping action.

17. The computer-readable medium according to claim 10, wherein the system further comprises at least one user interface control that when selected, causes the interface to filter the plurality of discovered computing entities.

18. The computer-readable medium according to claim 17, wherein the at least one user interface control comprises an input, and wherein the system accepts a user input that causes the interface to filter the plurality of discovered computing entities, and to display a filtered map of discovered computing entities that match the user input.

19. A method comprising:
discovering, via a management system, a plurality of computing entities coupled by one or more communication networks, the management system being coupled to the one or more communication networks;
representing, within a display of the management system, the plurality of discovered computing entities and associated connections in a plurality of dimensions in a graphical map; and
representing the plurality of discovered computing entities and their connections in the plurality of dimensions within a single end user display.

20. The method according to claim 19, further comprising an act of displaying, responsive to a user activation of at least one user interface control that when selected, causes the interface to display at a group of connections in at least one of the least one of the plurality of dimensions.

21. The method according to claim 19, further comprising an act of performing, responsive to a selection of a control, a zooming operation within the graphical map, wherein the zoom operation operates to select a zoom level with corresponding detail relating to the plurality of discovered computing entities.

22. The method according to claim 19, further comprising an act of creating, responsive to a selection of a control, a dependency between at least two entities, wherein one of at least one of the two entities is indicated to have a dependent relationship with the other of the at least two entities, and wherein the dependency relationship is indicated as a connection within the display.
